(19) United States
(12) Patent Application Publication
(10) Pub. No.: US 2024/0322621 A1
(43) Pub. Date: Sep. 26, 2024

(54) MOTOR

(71) Applicant: LG INNOTEK CO., LTD., Seoul (KR)

(72) Inventors: Moon Jae LEE, Seoul (KR); Jae Bin AN, Seoul (KR)

(21) Appl. No.: 18/694,501

(22) PCT Filed: Oct. 21, 2022
(86) PCT No.: PCT/KR2022/016136

§ 371 Date: Mar. 22, 2024

(30) Foreign Application Priority Data
Oct. 26, 2021 (KR) 10-2021-0144063
Dec. 13, 2021 (KR) 10-2021-0178011

(51) Int. Cl. H02K 1/18; H02K 1/2791; H02K 5/22; H02K 11/33

(52) U.S. Cl. CPC H02K 1/187; H02K 1/2791; H02K 5/225; H02K 11/33

(57) ABSTRACT

A motor comprises: a first housing; a stator which is arranged in the first housing and on which a coil is wound; a rotor arranged in the stator; a shaft arranged at the center of the rotor; a second housing arranged on the upper portion of the first housing; and a router which is arranged on the stator and has the shaft arranged at the center, wherein the router has a first hole, the first housing has a second hole facing the first hole, the second housing has a third hole facing the first hole and the second hole and screws coupled to the first hole, the second hole, and the third hole.

### TECHNICAL FIELD

The present embodiment relates to a motor.

### BACKGROUND ART

A motor is a device that converts electrical energy into rotational energy by using the force a conductor receives in a magnetic field. Recently, as the use of motors has expanded, the role of motors has become more important. In particular, as the electrification of automobiles progresses rapidly, the demand for motors being applied to steering systems, braking systems, and design systems is increasing significantly.

Typically, a motor is provided with a rotating shaft being formed to be rotatable, a rotor being coupled to the rotating shaft, and a stator being fixed to the inside of the housing. The stator is installed with a gap along the circumference of the rotor. Additionally, a coil that forms a rotating magnetic field is wound around the stator, causing electrical interaction with the rotor to induce rotation of the rotor. Therefore, as the rotor rotates, the rotating shaft rotates and generates driving force.

A bus bar electrically connected to the coil is disposed at an upper end of the stator. The bus bar generally includes a ring-shaped bus bar housing and a bus bar terminal to which a coil is connected by being coupled to the bus bar housing.

The busbar terminal may be provided with a plurality of terminals being directly connected to the coil, and each terminal may be processed with a portion bent due to space constraints or the location of the coil connection end.

The rotating shaft may be rotatably supported inside the housing by a bearing. At this time, the bearing may be disposed to be supported in the housing or may be installed by being press-fitted into the busbar housing.

In the case of the above-mentioned motor, since each part must be assembled inside the housing through several assembly processes, there are problems of production efficiency degradation and increase in manufacturing costs.

### DETAILED DESCRIPTION OF THE INVENTION

### Technical Subject

The present embodiment is intended to provide a motor capable of enhancing assemblability by improving the structure and lowering manufacturing costs by reducing the number of parts.

In addition, it is intended to provide a motor capable of effectively alleviating external impact or vibration.

### Technical Solution

A motor according to the present embodiment comprises: a first housing; a stator being disposed in the first housing and on which a coil is wound; a rotor being disposed inside the stator; a shaft being disposed at the center of the rotor; a second housing being disposed at an upper portion of the first housing; and a router being disposed on the stator and having the shaft being disposed at the center, wherein the router includes a first hole, wherein the first housing includes a second hole facing the first hole, wherein the second housing includes a third hole facing the first hole and the second hole, and wherein screws being coupled to the first hole, the second hole, and the third hole are included.

The first housing includes a first side surface portion and a first upper surface portion being bent outward from an upper end of the first side surface portion, and the second hole may be disposed in the first upper surface portion.

The second housing includes a second upper surface portion being disposed on an upper surface of the first upper surface portion, a second side surface portion being disposed on a side surface of the first upper surface portion, and a second lower surface portion being disposed on a lower surface of the first upper surface portion, wherein the third hole may be disposed on the second lower surface portion.

The router includes a router body and a protruded portion being protruded in a radial direction from the router body, wherein the first hole may be disposed in the protruded portion.

A groove having a shape being more radially recessed than other regions is disposed on the second upper surface portion, and an end of the protruded portion may be coupled to the groove.

A guide groove into which the coil is coupled may be disposed on an upper surface of the router body.

The guide groove may be provided in plural and disposed to be mutually partitioned along a radial direction.

A bushing made of an insulating material may be disposed between the first hole and the screw.

The shaft, the router, and the rotor may be formed integrally.

A controller being disposed inside the second housing and electrically connected to the coil may be included.

### Advantageous Effects

Through the present embodiment, in an integrated structure of a router, a rotor, and a shaft, the router is compactly coupled to the second housing together with the first housing, so there is an advantage in that parts for fixing the router can be omitted, thereby reducing the number of parts and assembly time.

Furthermore, the components inside the motor, including the router, can be firmly fixed inside the housing, so there is an advantage of preventing separation between different parts due to external impact.

In addition, there is an advantage in that a packing member can be disposed between the pluralities of housings to prevent external shocks from being transmitted to the components inside the motor.

In detail, the packing member absorbs vibration and impact being generated in various directions including a plurality of mutually perpendicular areas, so that components inside the motor can be protected.

In addition, since the packing member and the second housing are integrally formed, and the first housing, second housing, and router are coupled to each other through a single screw, there is an advantage in that assemblability is enhanced and manufacturing costs can be lowered by reducing the number of parts.

### BRIEF DESCRIPTION OF DRAWINGS

FIG. 1 is a perspective view of a motor according to a first embodiment of the present invention.

FIG. 2 is a plan view illustrating an upper surface of a motor according to a first embodiment of the present invention.

FIG. 3 is a cross-sectional view of a motor according to a first embodiment of the present invention.

FIG. 4 is an enlarged view of A in FIG. 3.

FIG. 5 is an exploded perspective view of a motor according to a first embodiment of the present invention.

FIG. 6 is a perspective view illustrating the appearance of a motor according to a second embodiment of the present invention.

FIG. 7 is a cross-sectional view of a motor according to a second embodiment of the present invention.

FIG. 8 is an exploded perspective view of a motor according to a second embodiment of the present invention.

FIG. 9 is a view for explaining a coupling structure of a second housing and a packing member according to a second embodiment of the present invention.

### BEST MODE

Hereinafter, preferred embodiments of the present invention will be described in detail with reference to the accompanying drawings.

However, the technical idea of the present invention is not limited to some embodiments to be described, but may be implemented in various forms, and inside the scope of the technical idea of the present invention, one or more of the constituent elements may be selectively combined or substituted between embodiments.

In addition, the terms (including technical and scientific terms) used in the embodiments of the present invention, unless explicitly defined and described, can be interpreted as a meaning that can be generally understood by a person skilled in the art, and commonly used terms such as terms defined in the dictionary may be interpreted in consideration of the meaning of the context of the related technology.

In addition, terms used in the present specification are for describing embodiments and are not intended to limit the present invention.

In the present specification, the singular form may include the plural form unless specifically stated in the phrase, and when described as “at least one (or more than one) of A and B and C”, it may include one or more of all combinations that can be combined with A, B, and C.

In addition, in describing the components of the embodiment of the present invention, terms such as first, second, A, B, (a), and (b) may be used. These terms are merely intended to distinguish the components from other components, and the terms do not limit the nature, order or sequence of the components.

And, when a component is described as being ‘connected’, ‘coupled’ or ‘interconnected’ to another component, the component is not only directly connected, coupled or interconnected to the other component, but may also include cases of being ‘connected’, ‘coupled’, or ‘interconnected’ due that another component between that other components.

In addition, when described as being formed or arranged in “on (above)” or “below (under)” of each component, “on (above)” or “below (under)” means that it includes not only the case where the two components are directly in contact with, but also the case where one or more other components are formed or arranged between the two components. In addition, when expressed as “on (above)” or “below (under)”, the meaning of not only an upward direction but also a downward direction based on one component may be included.

A motor according to the invention can be disposed inside a vehicle. As an example, a motor according to the present invention may be a component of a controller in a vehicle.

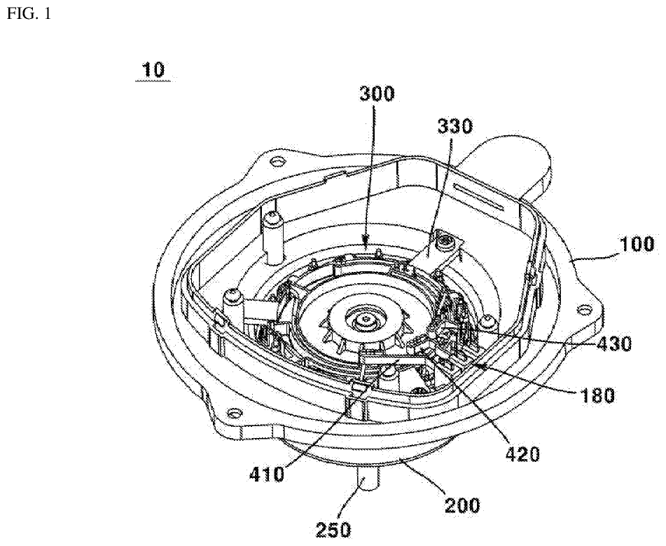

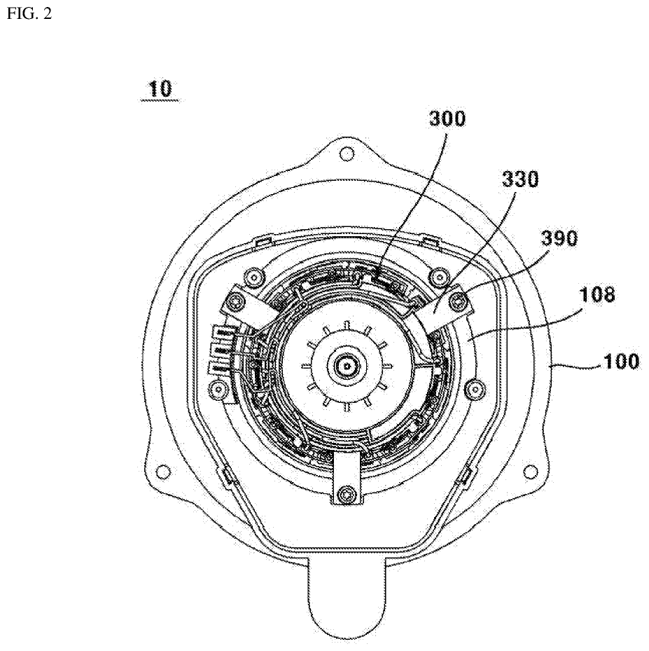

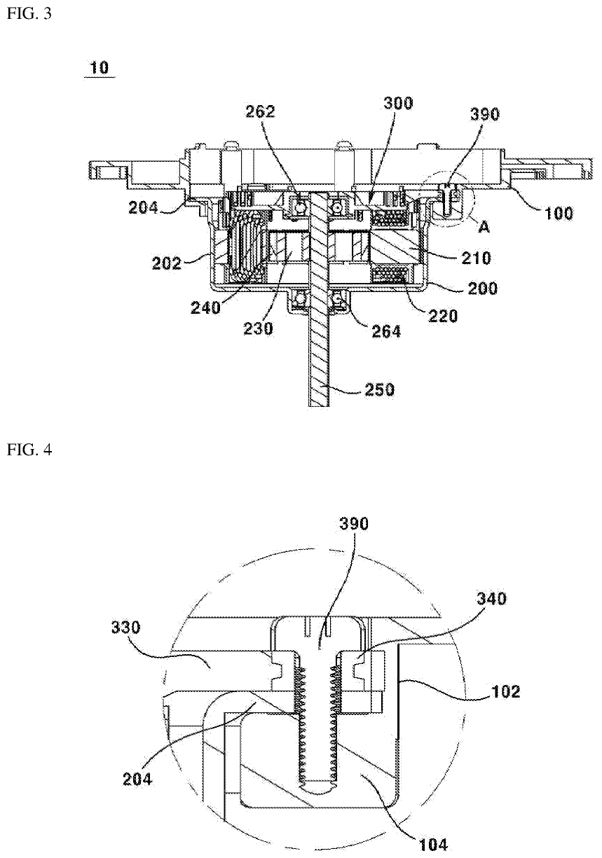

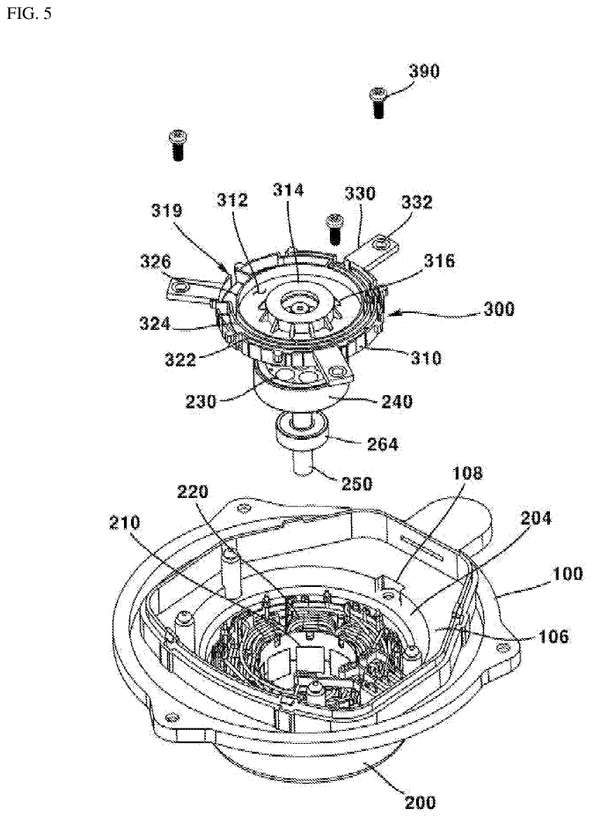

FIG. 1 is a perspective view of a motor according to a first embodiment of the present invention; FIG. 2 is a plan view illustrating an upper surface of a motor according to a first embodiment of the present invention; FIG. 3 is a cross-sectional view of a motor according to a first embodiment of the present invention; FIG. 4 is an enlarged view of A in FIG. 3; and FIG. 5 is an exploded perspective view of a motor according to a first embodiment of the present invention.

Referring to FIGS. 1 to 5, a motor 10 according to a first embodiment of the present invention may include a first housing 200, a second housing 100, a stator 210, a rotor 230, a shaft 250, and a router 300.

An upper surface of the first housing 200 may be open. The first housing 200 can accommodate the stator 210, the rotor 230, and the router 300 therein. The first housing 200 may be referred to as a motor housing. The first housing 200 may be disposed at a lower portion of the second housing 100.

The first housing 200 may have a can shape with a circular cross-section. The first housing 200 may include a first side surface portion 202 and a first upper surface portion 204. The first side portion 202 may form a space inside thereof to accommodate the stator 210, the rotor 230, and the router 300. The first upper surface portion 204 may be bent outward from an upper end of the first side surface portion 202 and coupled to the second housing 100. The first upper surface portion 204 may be disposed perpendicular to the first side surface portion 202.

A hole may be formed in a lower surface of the first housing 200 to allow the shaft 250 to penetrate therethrough.

The stator 210 may be disposed inside the first housing 200. The stator 210 may include a stator core, an insulator surrounding an outer surface of the stator core, and a coil 220 being wound around the insulator. Both ends of the coil 220 are extended upward from the stator core and may be guided by the router 300.

The rotor 230 may be disposed inside the stator 210. The rotor 230 may include a rotor core and a magnet 230 being coupled to the rotor core. As an example, the magnet 230 may be disposed on an outer circumferential surface of the rotor core. The magnet 230 may be disposed to face the coil 220. Therefore, the rotor 230 can rotate together with the shaft 250 due to electromagnetic interaction between the magnet 230 and the coil 220.

The shaft 250 is coupled to the center of the rotor 230 and can rotate together with the rotor 230. Both ends of the shaft 250 may be extended upward and downward directions of the first housing 200, respectively. The lower end of the shaft 250 may be protruded downward from the first housing 200 through a hole formed in a lower surface of the first housing 200.

Bearings 262 and 264 may be disposed inside the first housing 200 to support rotation of the shaft 250. The bearings 262 and 264 are disposed at an upper portion of the rotor 230 and support the upper end of the shaft 250, and the upper bearing 262 is disposed at a lower portion of the rotor 230 and may include a lower bearing 264 that supports rotation of the shaft 250. The space where the first and second bearings 262 and 264 are located inside the first housing 200 may have a groove shape being more recessed than other regions.

The second housing 100 may be disposed at an upper portion of the first housing 200. The cross-sectional area of the second housing 100 may be larger than the cross-sectional area of the first housing 200. The second housing 100 may be formed with an open upper surface and a lower surface. The second housing 100 may be referred to as a controller housing in that a controller such as a printed circuit board for controlling the motor 10 can be coupled to the second housing 100.

The second housing 100 may be coupled to surround the first upper surface portion 204 of the first housing 200. In detail, the second housing 100 may comprise: a second upper surface portion 106 being coupled to an upper surface of the first upper surface portion 204; a second side surface portion 102 being coupled to a side surface of the first upper surface portion 204; and a second lower surface portion 104 being coupled to a lower surface of the first upper surface portion 204. The second upper surface portion 106, the second side surface portion 102, and the second lower surface portion 104 have a cross-sectional shape of approximately letter “⊏”, and accordingly, it can be coupled to surround the first upper surface portion 204.

A cover (not shown) is coupled to an open upper surface of the second housing 100 to cover the space inside the second housing 100 from an external region.

The router 300 may be disposed at an upper portion of the stator 210. The router 300 may be disposed to cover an open upper portion of the first housing 200. The router 300 may be disposed to cover upper surfaces of the stator 210 and the rotor 230. The router 300 may be coupled to an upper end of the shaft 250. At least portion of the router 300 may be disposed inside the first housing 200 and another portion may be disposed inside the second housing 100. Unlike this, the router 300 may be selectively disposed only in one space among the spaces inside the first housing 200 or the second housing 100.

The router 300 may guide the coil 220 to guide both ends of the coil 220 to a preset position.

The router 300 may include a router body 310. The router body 310 has a circular cross-section and may have a predetermined thickness. A hole through which the shaft 250 penetrates may be formed in the center of the router body 310. A protruded region 314 being protruded upward may be formed in the center of an upper surface of the router body 310, and the upper bearing 262 may be disposed at a lower portion of the protruded region 314. Reinforcement ribs 316 may be disposed on a side surface of the protruded region 314 to reinforce the rigidity of the protruded region 314.

A plurality of guide grooves may be formed on an upper surface of the router body 310. The plurality of guide grooves may be disposed to correspond to the number of polarities of the coil 220. For example, when the coil 220 includes a plurality of coils having three different polarities, three guide grooves may be provided and disposed along the radial direction of the router body 310.

The plurality of guide grooves may be partitioned by different side walls. For example, the router body 310 may comprise: a first side wall forming an edge area of the router body 310; a second side wall 322 being disposed inside the first side wall; a third side wall 324 being disposed inside the second side wall 322; and a fourth side wall 326 being disposed inside the third side wall 324. Accordingly, the plurality of guide grooves may comprise: a first guide groove being disposed between the first side wall and the second side wall 322; a second guide groove being disposed between the second side wall 322 and the third side wall 324; and a third guide groove being disposed between the third side wall 324 and the fourth side wall 326.

A first coil of a first polarity may be disposed in the first guide groove. A second coil of a second polarity different from the first polarity may be disposed in the second guide groove. A third coil of a third polarity different from the first polarity and the second polarity may be disposed in the third guide groove.

Meanwhile, grooves 319 may be formed on the first side wall being disposed on the outermost side for the first to third coils to enter the first to third guide grooves, respectively.

Accordingly, the first coil to third coil are respectively disposed in the first to third guide grooves, and their respective ends may be coupled to the bus bars 410, 420, and 430. The bus bars 410, 420, and 430 are provided in numbers corresponding to the polarity of the coil 220, and one end is coupled to the coil 220 and may be coupled to the terminal guide 180. Here, the terminal guide 180 may have a shape being protruded upward from an upper surface of the first housing 200. Therefore, the controller can be electrically connected to the bus bars 410, 420, and 430 through the terminal guide 180. Accordingly, the motor 10 can be controlled through the controller.

The router 300 may be coupled with the first housing 200 and the second housing 100. To this end, the router 310 may include a protruded portion 330. The protruded portion 330 may have a shape being protruded outward in a radial direction from an outer surface of the router body 310. The protruded portion 330 may be provided in plural and disposed radially with respect to the router body 310. The plurality of protruded portion 330 may be disposed to be spaced apart from one another along the circumferential direction.

The protruded portion 330 may include a first hole 332 penetrating from an upper surface to a lower surface. The first hole 332 may be disposed adjacent to the end of the protruded portion 330.

A groove 108 may be formed in a second upper surface portion 106 of the second housing 100 in a shape being recessed radially more outward than other regions. At least a portion of the protruded portion 330 may be coupled to the groove 108. The groove 108 may accommodate the end of the protruded portion 330.

A second hole penetrating from an upper surface to a lower surface may be formed in the first upper surface portion 204 of the first housing 200 facing the groove 108 in a vertical direction. The second hole may be disposed to face the first hole 332 in a vertical direction.

A third hole may be formed in the second lower surface portion 104 of the second housing 100 that surrounds the lower surface of the first upper surface portion 204. The third hole may be disposed to face the first hole 332 and the second hole in a vertical direction. The third hole may be a groove being recessed downward from an upper surface of the second lower surface 104.

Therefore, the screw 390 is coupled downward from an upper region of the second upper surface portion 106, so that the router 300, the first housing 200, and the second housing 100 may be coupled to each other. In this case, the screw 390 may sequentially penetrate through the second hole and the first hole 332 and be screw-coupled into the third hole.

Meanwhile, for insulation, a bushing 340 made of an insulating material may be disposed between the inner surface of the first hole 332 and the screw 390. The bushing 340 may be formed along an upper surface of the protruded portion 330, the inner surface of the first hole 332, and the lower surface of the protruded portion 330.

According to the above structure, in the integrated structure of the router 300, since the rotor 240, and the shaft 250, the router 300 are compactly coupled to the second housing 100 together with the first housing 200, parts for fixing the router can be omitted, there is an advantage in that the number of parts and assembly time can be reduced.

Furthermore, components inside the motor, including the router 300, can be firmly fixed

inside the housings 100 and 200, there is an advantage in that separation between different parts due to an external impact can be prevented.

Hereinafter, a motor according to a second embodiment will be described.

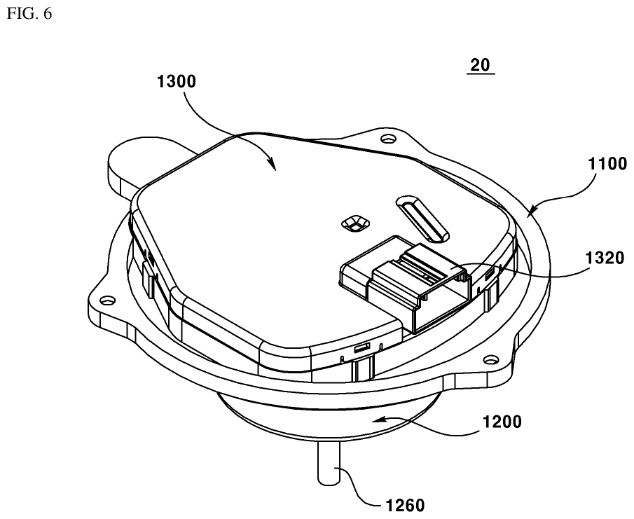

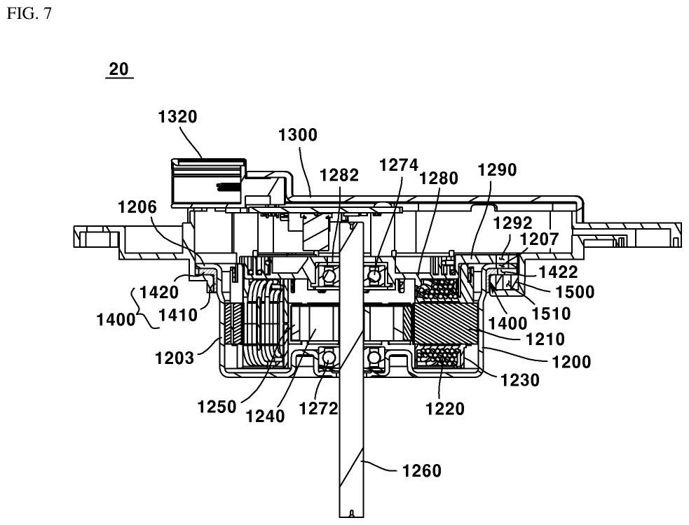

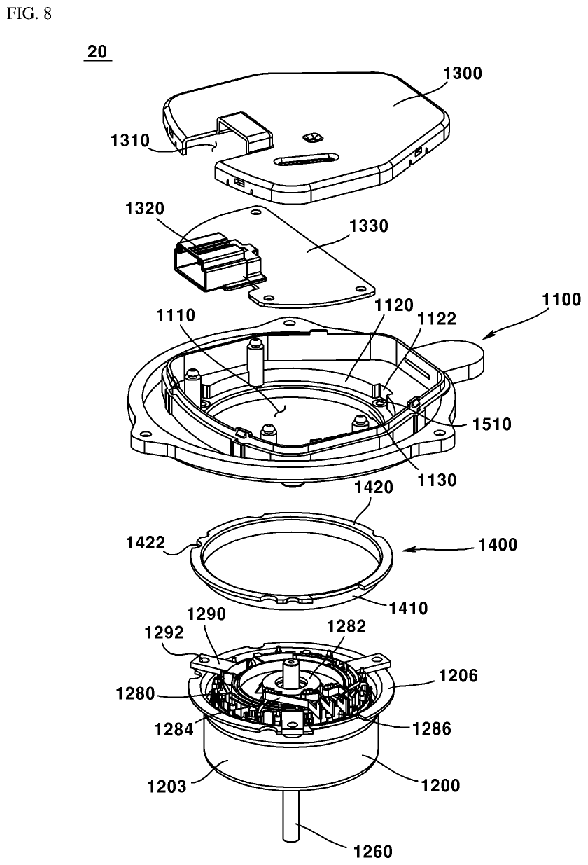

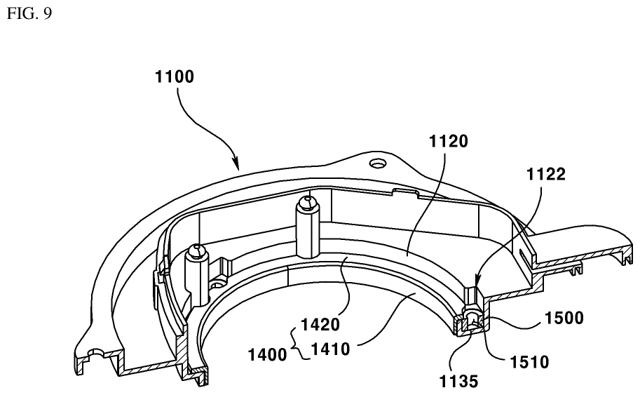

FIG. 6 is a perspective view illustrating the appearance of a motor according to a second embodiment of the present invention; FIG. 7 is a cross-sectional view of a motor according to a second embodiment of the present invention; FIG. 8 is an exploded perspective view of a motor according to a second embodiment of the present invention; and FIG. 9 is a view for explaining a coupling structure of a second housing and a packing member according to a second embodiment of the present invention.

Referring to FIGS. 6 to 9, a motor 20 according to the second embodiment of the present invention may comprise: a first housing 1200; a second housing 1100; a stator 1210; a rotor 1240; a shaft 1260; and a router 1280.

An upper surface of the first housing 1200 may be open. The first housing 1200 can accommodate the stator 1210, the rotor 1240, and the router 1280 therein. The first housing 1200 may be referred to as a motor housing. The first housing 1200 may be disposed at a lower portion of the second housing 1100.

The first housing 1200 may have a can shape with a circular cross-section. The first housing 1200 may include a first side surface portion 1203 and a first upper surface portion 1206. The first side portion 1203 may form a space inside thereof to accommodate the stator 1210, the rotor 1240, and the router 1280. The first upper surface portion 1206 may be bent outward from an upper end of the first side surface portion 1203 and coupled to the second housing 1100. The first upper surface portion 1206 may be disposed perpendicular to the first side surface portion 1203.

A hole may be formed in a lower surface of the first housing 1200 to allow the shaft 1260 to penetrate therethrough.

The stator 1210 may be disposed inside the first housing 1200. The stator 1210 may include a stator core, an insulator 1230 surrounding an outer surface of the stator core, and a coil 1220 being wound around the insulator. Both ends of the coil 1220 are extended upward from the stator core and may be guided by the router 1280.

The rotor 1240 may be disposed inside the stator 1210. The rotor 1240 may include a rotor core and a magnet 1250 being coupled to the rotor core. As an example, the magnet 1250 may be disposed on an outer circumferential surface of the rotor core. The magnet 1250 may be disposed to face the coil 1220. Therefore, the rotor 1240 can rotate together with the shaft 1260 due to electromagnetic interaction between the magnet 1250 and the coil 1220.

The shaft 1260 is coupled to the center of the rotor 1240 and can rotate together with the rotor 1240. Both ends of the shaft 1260 may be extended upward and downward directions of the first housing 1200, respectively. The lower end of the shaft 1260 may be protruded downward from the first housing 1200 through a hole formed in a lower surface of the first housing 1200.

Bearings 1272 and 1274 may be disposed inside the first housing 1200 to support rotation of the shaft 1260. The bearings 1272 and 1274 are disposed at an upper portion of the rotor 1240 and support the upper end of the shaft 1260, and the upper bearing 1274 is disposed at a lower portion of the rotor 1240 and may include a lower bearing 1272 that supports rotation of the shaft 1260. The space where the upper and lower bearings 1272 and 1274 are located inside the first housing 1200 may have a groove shape being more recessed than other regions.

The second housing 1100 may be disposed at an upper portion of the first housing 1200. The cross-sectional area of the second housing 1100 may be larger than the cross-sectional area of the first housing 1200. The second housing 1100 may be formed with an open upper surface and a lower surface. The second housing 1100 may be referred to as a controller housing in that a controller such as a printed circuit board for controlling the motor 20 can be coupled to the second housing 1100.

Specifically, a cover 1300 that covers the upper surface of the second housing 1100 may be disposed at an upper portion of the second housing 1100. Additionally, a printed circuit board 1330 and a connector 1320 may be disposed between the cover 1300 and the second housing 1100. The printed circuit board 1330 may be disposed in a space inside the second housing 1100. Accordingly, when an external terminal is coupled to the connector, the components inside the motor 20 can be controlled through the printed circuit board 1330. To this end, the printed circuit board 1330 may be electrically connected to the coil 1220. A hole 1310 may be formed in the cover 1300 to allow the connector 1320 to be coupled thereto.

A hole 1110 to which the first housing 1200 is coupled may be formed on a lower surface of the second housing 1100. The hole 1110 may form a first region 1120 forming a first diameter and a second region 1130 forming a second diameter smaller than the first diameter. Each of the first region 1120 and the second region 1130 may be formed in a circular shape. The second region 1130 may be disposed at a lower portion of the first region 1120. The second region 1130 may have a step shape in which a portion of the inner surface of the first region 1120 is protruded inward. When the first housing 1200 and the second housing 1100 are coupled, the lower surface of the first upper surface portion 1206 of the first housing 1200 is in contact with the upper surface of the second region 1130, and a portion of the outer surface of the first side portion 1203 may be disposed to face the inner surface of the second region 1130. When viewed from the side surface, the cross-sectional shape of the second region 1130 may have a cross-sectional shape of approximately letter “ [symbol] ”.

The first region 1120 may include a first groove 1122. The first groove 1122 may have a shape in which a portion of the inner surface of the first region 1120 is recessed outward. The first groove 1122 may be provided in plural and disposed to be spaced apart from each other along the circumferential direction of the first region 1120.

In a region, among the upper surface of the second region 1130, forming the bottom surface of the first groove 1122, a second groove 1135 (see FIG. 9) being recessed more downward from the upper surface of the second region 1130 than other regions may be formed. A bushing 1500 may be disposed inside the second groove 1135. The bushing 1500 is formed in a ring shape and may include a first hole 1510 (see FIG. 9) in the center. A screw thread or screw groove may be formed on an inner surface of the first hole 1510.

The router 1280 may be disposed at an upper portion of the stator 1210. The router 1280 may be disposed to cover an open upper portion of the first housing 1200. The router 1280 may be disposed to cover upper surfaces of the stator 1210 and the rotor 1240. The router 1280 may be coupled to an upper end of the shaft 1260. At least portion of the router 1280 may be disposed inside the first housing 1200 and another portion may be disposed inside the second housing 1100. Unlike this, the router 1280 may be selectively disposed only in one space among the spaces inside the first housing 1200 or the second housing 1100.

The router 1280 may guide the coil 1220 to guide both ends of the coil 1220 to a preset position.

The router 1280 may include a router body. The router body has a circular cross-section and may have a predetermined thickness. A hole through which the shaft 1260 penetrates may be formed in the center of the router body. A protruded region 1282 being protruded upward may be formed in the center of an upper surface of the router body, and the upper bearing may be disposed at a lower portion of the protruded region 1282.

A plurality of guide grooves may be formed on an upper surface of the router body 1310. The plurality of guide grooves may be disposed to correspond to the number of polarities of the coil 1220. For example, when the coil 1220 includes a plurality of coils having three different polarities, three guide grooves may be provided and disposed along the radial direction of the router body.

The plurality of guide grooves may be partitioned by different side walls. For example, the router body may comprise: a first side wall forming an edge area of the router body; a second side wall being disposed inside the first side wall; a third side wall being disposed inside the second side wall; and a fourth side wall being disposed inside the third side wall. Accordingly, the plurality of guide grooves may comprise: a first guide groove being disposed between the first side wall and the second side wall; a second guide groove being disposed between the second side wall and the third side wall; and a third guide groove being disposed between the third side wall and the fourth side wall.

A first coil of a first polarity may be disposed in the first guide groove. A second coil of a second polarity different from the first polarity may be disposed in the second guide groove. A third coil of a third polarity different from the first polarity and the second polarity may be disposed in the third guide groove.

Meanwhile, grooves (not shown) may be formed on the first side wall being disposed on the outermost side for the first to third coils to enter the first to third guide grooves, respectively.

Accordingly, the first to third coils are respectively disposed in the first to third guide grooves, and their respective ends may be coupled to the bus bar 1284. The bus bar 1284 is provided in numbers corresponding to the polarity of the coil 1220, and one end is coupled to the coil 1220 and may be coupled to the terminal guide 1286. Here, the terminal guide 1286 may have a shape being protruded upward from an upper surface of the first housing 1200. Therefore, the controller can be electrically connected to the bus bar 1284 through the terminal guide 1286. Accordingly, the motor 20 can be controlled through the controller.

The router 1280 may be coupled with the first housing 1200 and the second housing 1100. To this end, the router 1280 may include a protruded portion 1290. The protruded portion 1290 may have a shape being protruded outward in a radial direction from an outer surface of the router body 1310. The protruded portion 1290 may be provided in plural and disposed radially with respect to the router body 1310. The plurality of protruded portion 1290 may be disposed to be spaced apart from one another along the circumferential direction. The end of the protruded portion 1290 may be protruded more outward than an outer surface of the first upper surface portion 1206 of the first housing 1200.

The protruded portion 1290 may include a second hole 1292 penetrating from an upper surface to a lower surface. The second hole 1292 may be disposed adjacent to the end of the protruded portion 1290. The second hole 1292 may be disposed to face the first hole 1510 in a vertical direction. At least a portion of the protruded portion 1290 may be coupled to the first groove 1122 in the first region 1120. The end of the protruded portion 1290 may be coupled to the first groove 1122.

In addition, a third hole 1207 (see FIG. 7) may be formed in the first upper surface portion 1206 of the first housing 1200. The third hole 1207 is formed to penetrate from an upper surface to a lower surface of the first upper surface portion 1206, and may be disposed to face the first hole 1510 and the second hole 1292 in a vertical direction.

Accordingly, the screw may penetrate through the second hole 1292 and the third hole 1207 and be screw-coupled to the first hole 1510, and accordingly, the first housing, the second housing 1100, and the router 1280 can be firmly coupled to one another.

Meanwhile, the motor 20 may include a packing member 1400. The packing member 1400 may be disposed between the first housing 1200 and the second housing 1100. The packing member 1400 is made of rubber or resin, and can be formed integrally with the second housing 1100, which is made of plastic, by insert injection.

The packing member 1400 may have a cross-sectional shape of letter “ [symbol] ”. The packing member 1400 may include a second side surface portion 1410 and a second upper surface portion 1420. The second upper surface portion 1420 and the second side surface portion 1410 may be disposed perpendicular to each other.

The second side surface portion 1410 may be disposed outside the first side surface portion 1203 of the first housing 1200. The second side surface portion 1410 may be disposed between the first side surface portion 1203 and the inner surface of the second region 1130.

The second upper surface portion 1420 may be disposed at a lower portion of the first upper surface portion 1206 of the first housing 1200. The second upper surface portion 1420 may be disposed between a lower surface of the first upper surface portion 1206 and an upper surface of the second region 1130. A groove 1422 may be formed in an edge region of the second upper surface portion 1420 being recessed more inward than other regions to allow the screw to penetrate through.

According to the above structure, there is an advantage in that the packing member 1400 can be disposed between the first housing 1200 and the second housing 1100 to prevent external impact from being transmitted to the internal components of the motor.

In detail, the packing member 1400 can protect components inside the motor by absorbing vibration and impact generated in various directions by including a plurality of mutually perpendicular regions.

In addition, since the packing member 1400 and the second housing 1100 are integrally formed, and the first housing 1200, the second housing 1100, and the router 1280 are coupled to one another through a single screw, there is an advantage in that assemblability is enhanced and manufacturing costs can be lowered due to a reduction in the number of parts.

In the above description, it is described that all the components constituting the embodiments of the present invention are combined or operated in one, but the present invention is not necessarily limited to these embodiments. In other words, within the scope of the present invention, all of the components may be selectively operated in combination with one or more. In addition, the terms “comprise”, “include” or “having” described above mean that the corresponding component may be inherent unless specifically stated otherwise, and thus it should be construed that it does not exclude other components, but further include other components instead. All terms, including technical and scientific terms, have the same meaning as commonly understood by one of ordinary skill in the art unless otherwise defined. Terms used generally, such as terms defined in a dictionary, should be interpreted to coincide with the contextual meaning of the related art, and shall not be interpreted in an ideal or excessively formal sense unless explicitly defined in the present invention.

The above description is merely illustrative of the technical idea of the present invention, and those skilled in the art to which the present invention pertains may make various modifications and changes without departing from the essential characteristics of the present invention. Therefore, the embodiments disclosed in the present invention are not intended to limit the technical idea of the present invention but to describe the present invention, and the scope of the technical idea of the present invention is not limited by these embodiments. The protection scope of the present invention should be interpreted by the following claims, and all technical ideas within the equivalent scope should be interpreted as being included in the scope of the present invention.

1. A motor comprising:
a first housing;
a stator disposed inside the first housing and on which a coil is wound;
a rotor disposed inside the stator;
a shaft disposed at a center of the rotor;
a second housing disposed at an upper portion of the first housing; and
a router disposed on the stator to guide the coil and having the shaft disposed at a center,
wherein the router includes a first hole,
wherein the first housing includes a second hole facing the first hole,
wherein the second housing includes a third hole facing the first hole and the second hole, and
wherein screws coupled to the first hole, the second hole, and the third hole are included.

2. The motor according to claim 1,
wherein the first housing includes a first side surface portion and a first upper surface portion bent outward from an upper end of the first side surface portion, and
wherein the second hole is disposed in the first upper surface portion.

3. The motor according to claim 2,
wherein the second housing includes a second upper surface portion disposed on an upper surface of the first upper surface portion, a second side surface portion disposed on a side surface of the first upper surface portion, and a second lower surface portion disposed on a lower surface of the first upper surface portion, and
wherein the third hole is disposed on the second lower surface portion.

4. The motor according to claim 3,
wherein the router includes a router body and a protruded portion protruded in a radial direction from the router body, and
wherein the first hole is disposed in the protruded portion.

5. The motor according to claim 4,
wherein a groove having a shape more radially recessed than other regions is disposed on the second upper surface portion, and
wherein an end of the protruded portion is coupled to the groove.

6. The motor according to claim 4,
wherein a guide groove into which the coil is coupled is disposed on an upper surface of the router body.

7. The motor according to claim 6,
wherein the guide groove is provided in plural and disposed to be mutually partitioned along a radial direction.

8. The motor according to claim 1,
wherein a bushing made of an insulating material is disposed between the first hole and the screw.

9. The motor according to claim 1,
wherein the shaft, the router, and the rotor are formed integrally.

10. The motor according to claim 1, including:
a controller disposed inside the second housing and electrically connected to the coil.

11. The motor according to claim 4, wherein the protruded portion are plural, and
wherein the plurality of protruded portion are arranged along a circumferential direction with respect to the router body.

12. The motor according to claim 1, including an upper bearing supporting rotation of the shaft,
wherein the router body includes a protruding area where the upper bearing is disposed.

13. The motor according to claim 12, wherein a reinforcement ribs are disposed on a sides of the protruding area.

14. The motor according to claim 1, including a printed circuit board disposed in the second housing.

15. The motor according to claim 1, including a cover coupled to the second housing

16. A motor comprising:
a first housing;
a stator disposed in the first housing and on which a coil is wound;
a rotor disposed within the stator;
a shaft disposed at a center of the rotor;
a second housing disposed on an upper portion of the first housing and including a hole in a center to which the first housing is coupled; and
a packing member disposed between the first housing and the second housing.

17. The motor according to claim 16, wherein a material of the second housing is plastic, and
wherein a material of the packing member is rubber.

18. The motor according to claim 16, wherein the hole includes a first area forming a first diameter and a second area forming a second diameter smaller than the first diameter,
wherein the first housing includes a first side portion and a first upper surface portion bent outward from a top of the first side portion,
wherein a lower surface of the first upper surface portion faces an upper surface of the second area, and
wherein an outer surface of the first side portion faces an inner surface of the second area.

19. The motor according to claim 18, wherein the packing member includes a second upper surface portion disposed between a lower surface of the first upper surface portion and an upper surface of the second area, and a second side portion disposed between an outer surface of the first side portion and an inner surface of the second area.

20. The motor according to claim 18, wherein the first upper surface portion is screwed to an upper surface of the second area.
